(19) United States
(12) Patent Application Publication
(10) Pub. No.: US 2022/0086641 A1
(43) Pub. Date: Mar. 17, 2022

(54) Private Enterprise Network Identifier

(71) Applicant: Celona, Inc., Cupertino, CA (US)

(72) Inventor: Srinivasan Balasubramanian, San Diego, CA (US)

(21) Appl. No.: 17/471,673

(22) Filed: Sep. 10, 2021

Related U.S. Application Data
(60) Provisional application No. 63/077,537, filed on Sep. 11, 2020.

(51) Int. Cl. H04W 12/086; H04W 12/42; H04W 84/04

(52) U.S. Cl. CPC H04W 12/086; H04W 84/045; H04W 12/42

(57) ABSTRACT

Additional identifiers are provided to allow unique enterprise campus credentials to be implemented. In particular, a unique identifying credential is provided that does not involve providing a direct input from the user, apart from generic policy settings that can be controlled by the user. The use of a unique identifier allows provisioned parameterization of the device to be controlled based on the MNO policy and the enterprise network operational needs.

### CROSS-REFERENCE TO RELATED APPLICATIONS—CLAIM OF PRIORITY

The present application claims priority to U.S. Provisional Application No. 63/077,537, filed Sep. 11, 2020, entitled “CBRS Private Enterprise ESIM Identification”, which is herein incorporated by reference in its entirety.

### BACKGROUND

### (1) Technical Field

The disclosed method and apparatus relate generally to systems Private Enterprise Networks (PENs) and the devices that communicate with them. In particular, the disclosed method and apparatus relates to identifying PENs and engaging with those networks.

### (2) Background

The wireless industry has experienced tremendous growth in recent years. Wireless technology is rapidly improving, and faster and more numerous broadband communication networks have been installed around the globe. These networks have now become key components of a worldwide communication system that connects people and businesses at speeds and on a scale unimaginable just a couple of decades ago. The rapid growth of wireless communication is a result of increasing demand for more bandwidth and services. This rapid growth is in many ways supported by standards. For example, 4G LTE has been widely deployed over the past years, and the next generation system, 5G NR (New Radio) is now being deployed. In these wireless systems, multiple mobile devices are served voice services, data services, and many other services over wireless connections so they may remain mobile while still connected.

Wireless networks have a wide range of applications and uses. Enterprises particularly have a great interest in implementing wireless networks at their enterprise location to improve efficiency and reduce costs. For the purposes of this disclosure, an enterprise may be a business, such as a large multi-national corporation, a small business, such as a car dealership, a governmental agency, or any other organization having a particular campus on which it would be useful for the enterprise to have access to a private wireless enterprise communication network (an “enterprise network”). Enterprises benefit from optimizing their computing, storage and networking infrastructure, and improving performance of the business applications within their business location. For this purpose, wireless network systems that make effective use of the spectrum within a business enterprise for wireless communication, improve the efficiency of communication within the organization and between the organization and the external entities. This improved communication capability at the enterprise location increases business efficiency and reduces cost. Business use cases include: fixed wireless Internet service; in building PEN service; mobile broadband networks; industrial IoT; educational IoT; health IoT; communications within public venues (sports stadiums, airports, shopping malls, hotels, etc.), neutral host, etc.

FIG. 1 is an illustration of a basic configuration for a communication network 100, such as a “4G LTE” (fourth generation Long-Term Evolution) or “5G NR” (fifth generation New Radio) network. Through this network configuration, user equipment (UE) 101 can connect to External Packet Data Networks (PDNs) 103 and access any of a variety of services such as the Internet, Application Servers, Data Services, Voice Services, and others.

### UEs

As used herein, the term “UE” refers to a wide range of user devices having wireless connectivity, such as a cellular mobile phone, an Internet of Things (TOT) device, virtual reality goggles, robotic devices, autonomous driving machines, smart barcode scanners, and communications equipment including for example cell phones, desktop computers, laptop computers, tablets and other types of personal communications devices. In some cases, the UEs may be mobile; in other cases, they may be installed at a fixed location. For example, a factory sensor may be installed at a fixed location from which it can remotely monitor an assembly line or a robotic arm's movement. In the illustration of FIG. 1, the UEs 101 include a first mobile phone 101a, a second mobile phone 101b, a laptop computer 101c, and a printer 101d.

The UEs 101 connect wirelessly over communication links 105 to a Radio Access Network (RAN) 107 that includes a base station/access point (BS/AP) 109. One of the advantages of such networks is their ability to provide communications to and from multiple UEs and provide these wireless UEs with access to a large number of other devices and services even though the devices may be mobile and moving from location to location.

### BS/APs

The term ‘BS/AP” is used broadly herein to include base stations and access points, including at least an evolved NodeB (eNB) of an LTE network or gNodeB of a 5G network, a cellular base station (BS), a Citizens Broadband Radio Service Device (CBSD) (which may be an LTE or 5G device), a Wi-Fi access node, a Local Area Network (LAN) access point, a Wide Area Network (WAN) access point, and should also be understood to include other network receiving hubs that provide access to a network of a plurality of wireless transceivers within range of the BS/AP. Typically, the BS/APs are used as transceiver hubs, whereas the UEs are used for point-to-point communication and are not used as hubs. Therefore, the BS/APs transmit at a relatively higher power than the UEs.

### Core Network

The RAN 107 connects the UEs 101 with the Core Network 111. One function of the Core Network 111 is to provide control of wireless signaling between the UEs 101 and the RAN 107, and another function is to provide access to other devices and services either within its network, or on other networks such as the External PDNs 103. Particularly, in cellular networks and in private networks, the BS/AP 109 can receive wireless signals from, and send wireless signals to, the UEs 101. The RAN 107 is coupled to the core network 111; therefore, the RAN 107 and the Core Network 111 provide a system that allows information to flow between a UE in the cellular or private network and other networks, such as the Public Switched Telephone Network (PSTN) or the Internet. Wireless data transmission between a UE 101 and the BS/AP 109 occurs on an assigned channel, such as a specific frequency. Data transmission between the BS/AP 109 and the Core Network 111 utilizes any appropriate communication means, such as wireless, cable, and fiber optic.

In addition to providing access to remote networks and allowing information to flow between the cellular network and the external PDNs 103, the Core Network 111 provides control of the air interface between the BS/AP 119 and the UEs 101. The Core Network 111 may also coordinate the BS/APs 109 to minimize interference within the network.

### MNO Networks

Mobile Network Operator (MNO) networks are relatively large networks of cellular towers that provide cellular phones and other UEs access to a public wireless communications network operated by an MNO, such as Sprint, Verizon, T-Mobile, etc. These networks typically conform to the 3G, 4G and 5G industry standards over frequencies assigned by the Federal Communications Commission (FCC).

### CBRS Networks

Another type of wireless network that recently became available for general use by enterprises at their enterprise locations is a Citizen's Broadband Radio Service (CBRS) network. These CBRS networks utilizes the CBRS radio band of 3550-3700 MHz, nominally divided into fifteen channels of 10 MHz each. Particularly, the FCC recently approved use of the CBRS band of the frequency spectrum and finalized rules (Rule 96) that allow general access to the CBRS band. The CBRS rules set forth detailed requirements for the devices that operate in a CBRS network and how they communicate. CBRS supports both LTE and 5G devices.

Reference is now made to FIG. 2, which is a diagram of a wireless communication network implemented as an enterprise network using a CBRS system. A plurality of BS/APs 201a, 201b, 201c, 201d are deployed in an enterprise location 200. It should be noted that throughout this disclosure, a reference string (such as “201a”) used to identify a feature in a figure, having a string of numeric characters followed by one or more alphabetic characters, identifies a feature of the figure that is similar to other features in the figures having the same numeric string of characters. For example, the BS/AP 201a is similar to the BS/AP 201b, 201c and 201d. Furthermore, a reference string having only the numeric string (i.e., lacking the alphabetic characters) refers collectively to all of the features having the same numeric string. For example, the BS/AP 201 refers collectively to all four of the BS/APs 201a, 201b, 201c and 201d.

In FIG. 2, each BS/AP 201 has a range, defining a wireless coverage area. The BS/APs 201 may be CBSDs in a CBRS system. A first UE 202a is wirelessly connected to a first BS/AP 201a, which is providing service to it. A second UE 202b is wirelessly connected to a second BS/AP 201b, and is providing service to that second UE 202b. Other UEs 202, which connect to the BS/APs 201, are shown in the enterprise location 200. All the BS/APs 201 are connected to a PDN 220 by any appropriate communication means, such as wire, fiber optic, and wireless radio. The PDN 220 provides a connection to an operator network 222 that includes an Oracle (OAM) Server 207, a SON assist unit 208, a Domain Proxy 209, an Automatic Configuration Server (ACS) 210 and a Location Database 211, all of which are connected to each other within the operator network 222 by any appropriate means. The MNO network is connected to an SAS 212, which is connected to a Spectrum Database 213 that includes data regarding the spectrum that SAS 212 is managing. Collectively, the SAS 212 and the Spectrum Database 213 are referred to as a Spectrum Management Entity (SME) 214.

In some of the literature, BS/APs 201 within a CBRS network are termed “CBSDs”, and UEs 202 are termed End User Devices (EUDs). CBSDs are fixed Stations, or networks of such stations, that operate on a Priority Access (PA) or General Authorized Access (GAA) basis in the CBRS band consistent with Title 47 CFR Part 96 of the United States Code of Federal Regulations (CFR).

The CBRS rules require that a Spectrum Access System (SAS) allocate spectrum to the CBSDs to avoid interference within the CBRS band. The Spectrum Access System (SAS) is a service, typically cloud-based, that manages the spectrum used in wireless communications of devices transmitting in the CBRS band, in order to prevent harmful interference to higher priority users such as the military and priority licensees. A CBRS device (CBSD) needs authorization from the SAS before starting to transmit in the CBRS band. Even after authorization, the SAS may suspend or terminate authorization of one or more the channels previously authorized.

Regardless of complexities, the CBRS band provides an opportunity to create new wireless networks, and there is a desire for utilizing and making maximum use of spectrum in the CBRS band while following the rules pertaining the CBRS usage, including effectively responding to directions from the SAS.

### UE Credentials

When a UE is operating across relatively large macro MNO networks and enterprise networks, the UE needs to use generic policies that aid in making transitions across the networks. The UE can maintain several enterprise credentials, each of which allow the UE to gain access one of the various enterprise networks. In addition, the UE can maintain a mechanism to identify which of the credentials would be appropriate for use for each of the campuses in each of the enterprise networks.

In addition to identifying which particular credentials are appropriate to use for each enterprise network, there are specific attributes that need to be associated with the identified credentials when the identified credentials are selected to be used. Given that a lot of the CBRS networks will use the same Public Land Mobile Network Identification (PLMNID), commonly referred to as a Shared Home Network Identifier (SHNI), additional identifiers are needed to recognize networks that operate on a specific enterprise campus and with which it is desireable to associate unique PEN credentials. Since there are a large number of UEs already deployed and for which it would be desirable to take advantage of such identifiers, establishing these needed additional identifiers is preferably done without involving direct input from the user, apart from identifying generic policy settings that can be controlled by the user. Between the MNO policy and enterprise network operational needs, the provisioned parameterization should allow for regulating the device operations.

The following table provides the hierarchy of identifiers that are current used.

```
A. LTE/EPC
    1. PLMN ID
      1. SHNI
      2. Private
      3. MNO
      4. SHNI + MNO
      5. Private + MNO
    2. A.1.x + CSG
    3. A.1.x + CSG + PSP ID
B. NR/5GC
    1. PLMN
      1. SHNI
      2. Private
      3. MNO
      4. MCC = 999
      5. SHNI + MNO
      6. Private + MNO
      7.MCC = 999 + MNO
    2. PLMN + CAG
    3. B.1.x + NID.x
    4. B.1.x + 5GC-NID.x + CAG
    5. B.1.x + CAG + PSP ID
  5GC-NID
      1. AM = 1
      2. AM = 0
      3. AM = 2
```

Closed Subscribers Group (CSG) identifies a group of subscribers who are permitted to access one or more CSG Cells of the PLMN. PLMN based selection for the UE is the baseline. Use of the CSG ID has been very minimally introduced into the market from a device perspective and is not a mainstream feature. Furthermore, PSP ID is not supported by the device ecosystem.

FIG. 3A is a table showing CBRS technology use cases and system selection mechanisms for LTE. For the Y/N markings, Y indicates a required feature and N indicates not a required feature. Features supported by the device ecosystem and viable alternatives for the market are marked with a capital letter (i.e., Y or N). Partially supported features and features that are not generally availability for the device ecosystem are marked with a capital letter in italics (Y or N). Features that are not supported by the device ecosystem are marked with a lower case letter (y or n).

FIG. 3B is a table showing CBRS technology use cases and system selection mechanisms for NR. The marking of Y/N/? indicates: “Y” indicates required feature; “N” indicated not a required feature; and “?” indicates no specific recommendation. The coding is as follows: Capital indicates that support of the feature is required from UEs; italics indicates that the feature maybe viable, but there is no direct recommendation from the CBRS forum regarding having this as a UE feature; lower case indicates that the feature is not a viable option and not recommended that the UE feature provide support.

Some of the specific features that need to be associated with the credentials of a UE include: (1) geofencing: in which it is necessary to find the enterprise network and use the appropriate credential; and (2) HTTP proxy support: Unlike MNO networks, enterprise campuses networks require additional security against attacks; (3) Voice and data offload to the enterprise network: which will depend on the type of offload the potential charges incurred for the end-user, MNO network with SLA to specific enterprise campuses, and enterprise network capabilities for feature support and interconnection with MNO network; (4) Relative priority and traffic routing policies between Wi-Fi and LTE/NR: wherein converged core and traffic steering primarily defines the efficiency of deployment; additionally, based on subscription, specific behaviors based on services and isolation for preferential operations will be part of the enterprise network feature offerings; (5) Charging rules that may apply: wherein the UE offloads traffic to different enterprise networks, well-defined policies are needed that can be provisioned to avoid unnecessary charges; (6) Expected SLO/SLA/grade of service.

Given that many CBRS networks use the same PLMN ID (SHNI), it is desireable to provide additional identifiers to allow unique enterprise campus credentials to be implemented. Current devices in the market do not support CSG ID based system camping. Furthermore, it may not be possible to include this parameter to identify the credential. The TAI is a network identifier and is not specific to the UE credential. The particular value of an International Mobile Subscriber Identifier (IMSI) within a range of IMSI values does not directly identify the enterprise network. Therefore, the value of the IMSI cannot be used to form a unique identifying credential. Furthermore, it would be desirable to provide a unique identifying credential that does not involve providing a direct input from the user, apart from generic policy settings that can be controlled by the user. It would be desirable for the provisioned parameterization to allow the operation of the device to be controlled based on the MNO policy and the enterprise network operational needs. The current profile definition does not cover allow such control by the MNO and enterprise network. Some customized solutions have been attempted, but such customizations have resulted in bifurcations in device management that has complicated enterprise deployments and that fail to yield consistent results across devices.

Accordingly, there is presently a desire for a method and apparatus for establishing needed additional identifiers without the direct involvement of a user.

### BRIEF DESCRIPTION OF THE DRAWINGS

The disclosed method and apparatus, in accordance with one or more various embodiments, is described with reference to the following figures. The drawings are provided for purposes of illustration only and merely depict examples of some embodiments of the disclosed method and apparatus. These drawings are provided to facilitate the reader's understanding of the disclosed method and apparatus. They should not be considered to limit the breadth, scope, or applicability of the claimed invention. It should be noted that for clarity and ease of illustration these drawings are not necessarily made to scale.

FIG. 1 is an illustration of a basic configuration for a communication network, such as a “4G LTE” (fourth generation Long-Term Evolution) or “5G NR” (fifth generation New Radio) network.

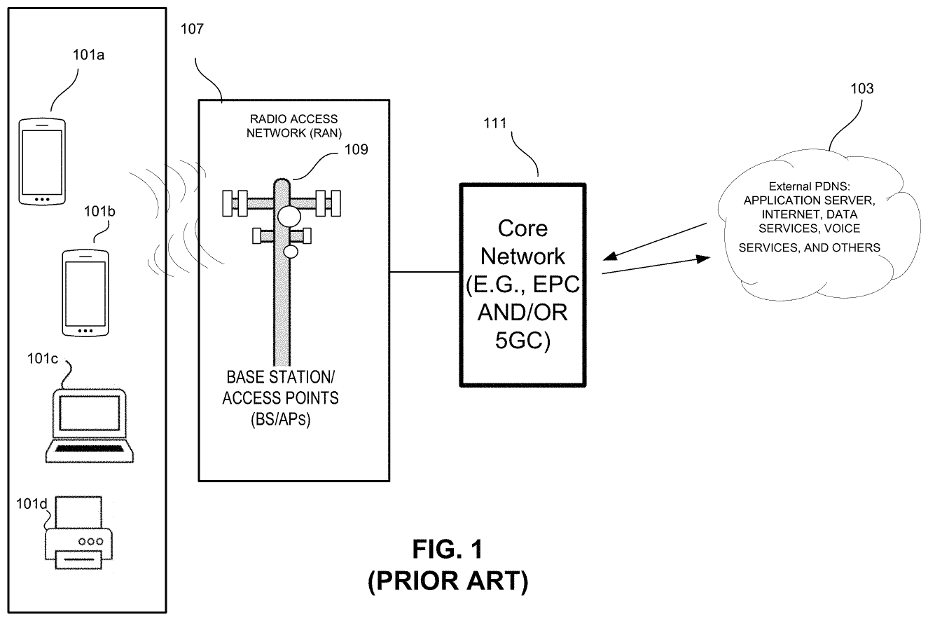

FIG. 2 illustrates each BS/AP having a range, defining a wireless coverage area.

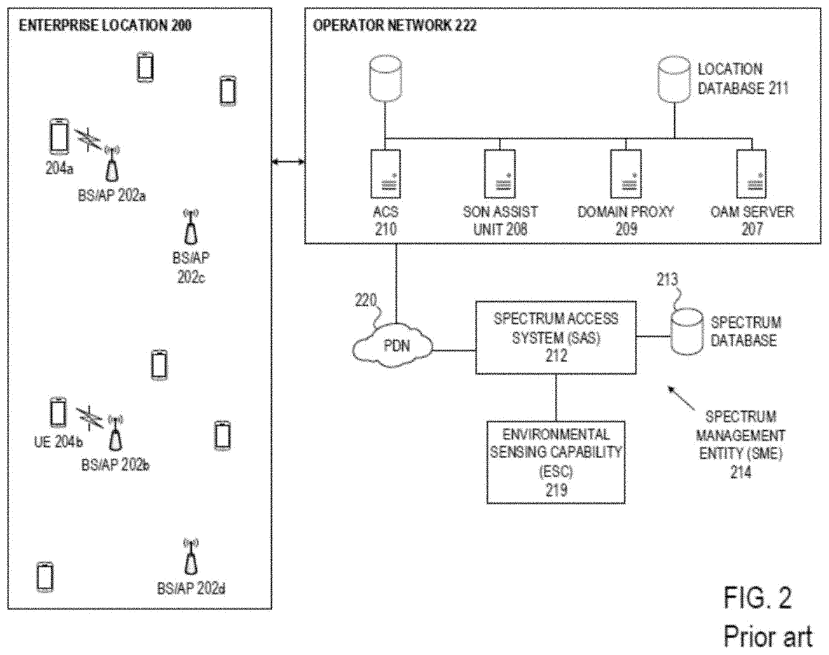

FIG. 3A is a table showing CBRS technology use cases and system selection mechanisms for LTE.

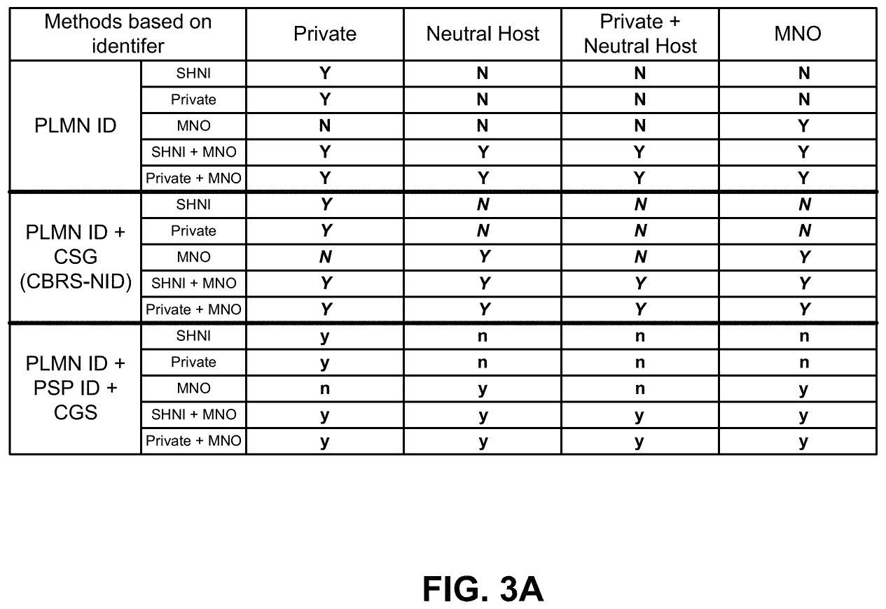

FIG. 3B is a table showing CBRS technology use cases and system selection mechanisms for NR.

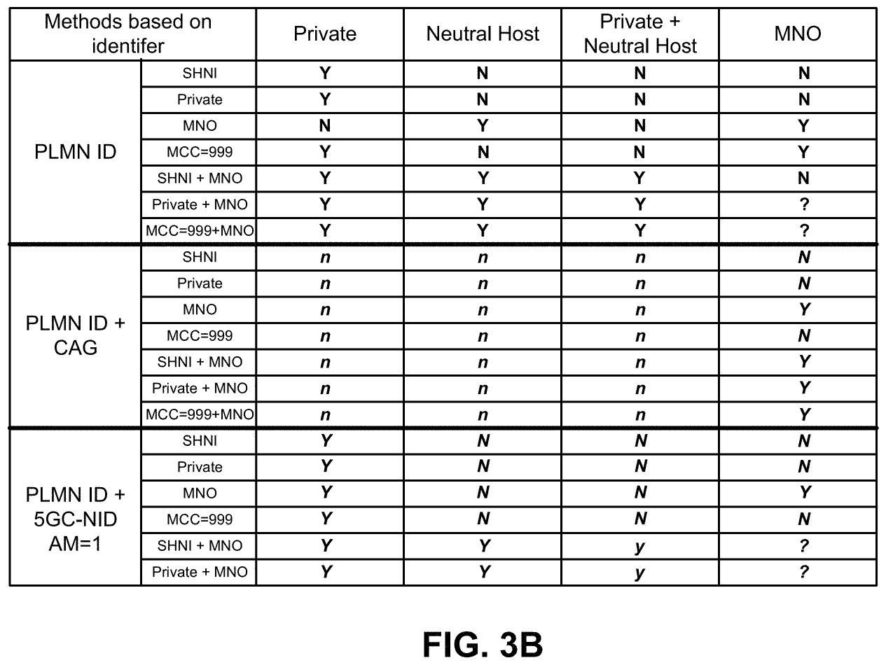

FIG. 4 illustrates the use of four different sets of shapes for assisting in determining the coverage area of a private enterprise network.

FIG. 5 is a diagram showing some of the Elementary Files (EFs) within the dedicated file (DF) for the home NodeB (DF_{HNB}).

The figures are not intended to be exhaustive or to limit the claimed invention to the precise form disclosed. It should be understood that the disclosed method and apparatus can be practiced with modification and alteration, and that the invention should be limited only by the claims and the equivalents thereof.

### DETAILED DESCRIPTION

### Geofencing of Enterprise Campuses

There are several features that can be enabled by associating an enterprise deployment with a geofenced area. These features can be taken advantage of by both a network and a UE. For example, employing a geofence associated with an enterprise network allows a UE to perform power optimized scans when searching for a specific enterprise campus network.

From a network perspective, the use of geofencing primarily allows common address spaces to be managed better, avoiding potentially conflicts with other deployments. This problem of common address spaces is inherent in LTE private network deployments employing a Shared Home Network Identifier (SHNI) and obtaining an International Mobile Subscriber Identifier (IMSI) Block Number (IBN), E-UTRAN cell Global Identifier (ECGI), Global Unique MME (Mobility Management Entity) Identifier (GUMMEI), and Tracking Area Identifier (TAI). Even with the regulation, misuse can happen intentionally or unintentionally. This problem is particularly prevalent with TAIs, in part because only 6 are allocated to each IBN allocation. Such tight allocation restricts the number of deployments by the same entity within a given geographic area. This becomes less of an issue with a geofenced approach and the UE inherently avoiding regions where it does not need to look for Enterprise Networks.

Enterprise Networks vary in size and can require a coarse geofencing, covering a large area or potentially require building level geofencing to allow the UEs to determine the proximity to an Enterprise Network. Using GPS based geofencing alone may have power consumption implications on the UE side. Hence, other methods such as MNO network radio footprint can be considered. Obtaining the GPS location of enterprise eNBs during deployment allows a rough estimate of the radio coverage of the campus to be determined. However, such estimates are not accurate representations of the RF footprint of the Enterprise Network.

In accordance with some embodiments of the disclosed method and apparatus, geofencing information is specified as including GPS information, radio footprint information, or both. In some embodiments, the geofence information is provided based on predetermined shapes to define the boundaries of the enterprise campus. In some embodiments, the predetermined shapes comprise a set of ellipsoid points associated with uncertainty circles that together identify the boundaries of a private enterprise network (PEN). Alternatively, a polygon is defined by a set of connected points, each located by GPS coordinates, and the points being connected in sequence to one another, the last point then connected back to the initial point to establish the boundary of a PEN.

In addition, radio footprint information can be gathered and used to assist in determining the coverage area associated with a PEN. Furthermore, one or more public network Cell-IDs associated with signals received at locations within the PEN can be used to indicate a potential availability of an enterprise campus network when the UE enters these macro cells. In some embodiments, signal strengths associated with the signals carrying the Cell-IDs can be used to provide more precise locations, which can in turn be used to assist in determining where a UE should start looking for a PEN.

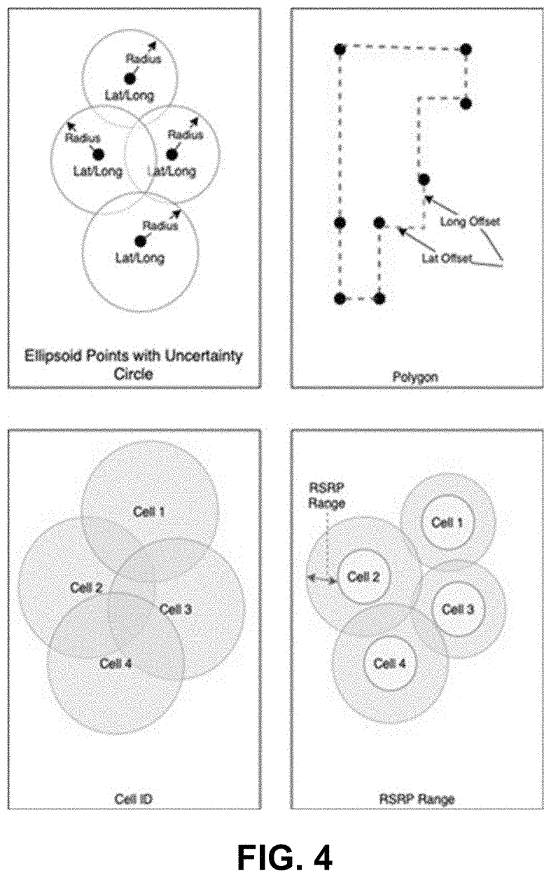

FIG. 4 illustrates the use of four different sets of shapes for assisting in determining the coverage area of a PEN.

Identifying a Private Enterprise pSIM/eSIM Credential

The disclosed method and apparatus provides a mechanism to associate credentials provisioned in the UE with, and as belonging to, a specific enterprises. In some embodiments, an Enterprise Identifier is included as part of the SIM profile configuration for both physical and embedded SIMs. The disclosed method and apparatus provides a pSIM/eSIM credential to be used as a private enterprise credential. Information regarding the private enterprise credential is made available to the UE for making policy decisions. Given that an approach is needed with the UE devices already in the market and planned new devices to be released in the immediate future, a solution with the currently defined standards is needed.

Each Enterprise Network preferably has a unique Enterprise Identifier. This identifier can be obtained through an independent organization that monitors and administrates the process of providing the identifiers. Accordingly, in some embodiments, requesting a CBRS NID from the administering organization when the network is using SHNI will result in the issuance of the Enterprise Identifier.

In some embodiments, the SIM credential provisioned in a UE that has access to the Enterprise Network is provisioned with this Enterprise Identifier. In some embodiments, the identifier may be used by the UE to identify geofence information that the UE can request for use in finding and gaining access to an the Enterprise Network.

In some embodiments, the Enterprise Identifier, or alternatively, a unique name associated with the identifier, is transmitted by an eNB. The UE uses the identifier to recognize the eNB prior to accessing the network. In some embodiments in which a name is transmitted, rather than the identifier itself, the Enterprise Identifier is converted to a text string that is then transmitted as a string.

Provisioning the identifier into the SIM credential provides a means by which the UE can determine the association of specific credentials with specific associated enterprise campuses. This association can further be used to identify policies and behaviors that the UE can employ when connecting with the Enterprise Network. The Enterprise Identifier can be employed by the UE to determine an associated Enterprise Information Server. Note that the UE can obtain the enterprise geofencing and policy information through other methods not explicitly covered in this disclosure.

The current SIM profile has the below parameters in it:

Campus IMSI Range

Campus SMS-C Address

Service Provider Name

Preferred Home PLMN List

Preferred Visitor PLMN List

Define Authentication Protocol (e.g., EAP, Milenage)

Define Access Control Class (ACC)

Services to enable (USIM, ISIM, 5G, etc.)

In some embodiments, the provisioning of the Enterprise Identifier in the SIM credential follows the definition in the SIM profile as defined below:

For 4G: The PLMN+Closed Subscribers Group (CSG)-ID (wherein the PLMN is the SHNI) is placed in the SIM Profile. The SIM profile must include the CSG-ID and can also support the Operator Home NodeB Name. This identifier can be obtained through OnGo Alliance by requesting for CBRS NID when the network is using a SHNI.

The Enterprise Identifier is specified in the SIM profile. In some embodiments, the CSG-ID is used to carry the Enterprise Identifier information as part of the SIM profile. In some such embodiments, given that a single credential can be applied to one or more enterprise deployments, the CSG-ID is supported as a list of entries.

Details of the CSG configuration are provided in 3GPP TS 31.102 “Technical Specification Group Core Network and Terminals; Characteristics of the Universal Subscriber Identity Module (USIM) application”, published by the Third Generation Partnership Project (3GPP). Specifics for provisioning the SIM to include the CSG-ID are provided below.
Details of the Dedicated File (DF) Home NodeB (DF_{HNB}) provisioning are provided below:

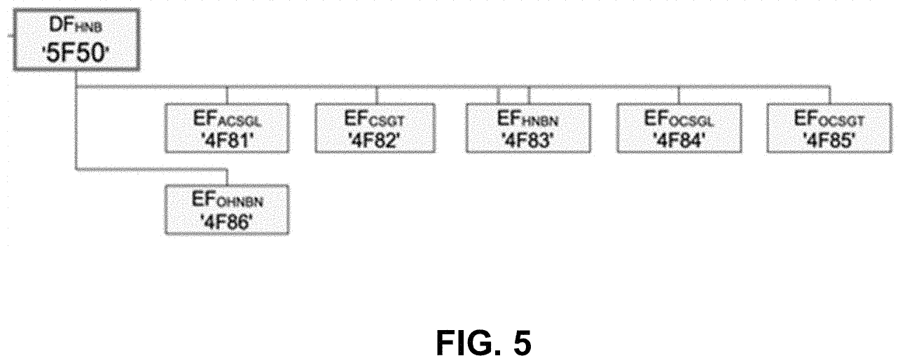

An Elementary File (EF) is defined for Operator CSG Lists (EF_{OCSGL}) by 3GPP TS 31.102. (Additional details are available in paragraph 4.4.6.5 of 3GPP TS 31.102). FIG. 5 is a diagram showing some of the EFs within the DF_{HNB}. In some embodiments, a PLMN Tag is set to an SHNI value of 315-010. Note that only one PLMN ID can be specified. In some embodiments, a list of CSG-IDs is specified. ‘CSG ID’ is set to the ‘CBRS NID’ purchased for the particular Enterprise entity. The CSG-ID is defined as per 3GPP TS 23.003 (i.e., having a 27 bit fix length value). This EF has tags to EF_{OCSGT} and EF_{OHNBN} that need to be mandatorily specified in accordance with the 3GPP specifications. An EF for the operator CSG type (EF_{OCSGT}) is described in paragraph 4.4.6.6 of 3GPP TS 31.102. The EF allows custom type information to be included. In some embodiments, a text string “Enterprise Private” in provided in this field. Another EF (EF_{OHNBN}) for a operator home NodeB name is provided in accordance with 3GPP TS 31.102, paragraph 4.4.6.6. The EF allows a home node B name to be included as a text string converting the CSG-ID field to text. In some embodiments, the information is matched with the CBSD SIBS broadcast by the UE.

Based on the above fields provided in the current SIM profile, as the UE approaches the Private Campus, the Service Provider Name within the eSIM Profile can be used to identify the private network. This field typically is the name associated with the PLMN that is used for display on the UE device display.

The Service Provider Name (SPN) will be displayed on the user interface (UI) of the UE. In some embodiments, this is a free formatted field. Standardizing a specific signature to the naming allows for easy recognition in the UE. In some embodiments, it is required that the SPN include a prefix or suffix with explicit text that identifies this credential to be private enterprise SIM profile. E.g., Celona:PESP

Use Cases for Identifying an pSIM/eSIM Credential to be Private Enterprise

In an PEN, a first case is a Private Enterprise UE (single-SIM). A second case is an MNO offload to an Enterprise UE (dual-SIM). In one such case, the device is locked. In an alternative case, the device is unlocked.

In a Neutral Host, a first case is presented in which the MNO UE transitions to a CBRS network to extend the UE coverage (single-SIM associated with the MNO). In a second case, the UE is an MNO roaming UE (single-SIM/dual-SIM).

In an Private Enterprise and Neutral Host Network, a first case is one in which a Private Enterprise UE (single-SIM associated with the private network) is present. A second case is one in which an MNO offload occurs to Enterprise UE (dual-SIM, one SIM associated with the MNO and a second associated with the private enterprise). In one such case, the device is locked. In an alternative case, the device is unlocked. In a third case, an MNO UE transitions to a CBRS network to extend the coverage for the UE (single-SIM associated with the MNO). In a fourth case is an MNO roaming UE (single-SIM/dual-SIM).

In an MNO Network, a first case has an MNO UE that transitions to a CBRS network to extend the coverage of the UE (single-SIM associated with the MNO). A second case has an MNO roaming UE (single-SIM/dual-SIM).

Some of the above use cases require the SIM profile to be identified as private, such as: (1) in the first case in which the UE is a PEN UE having: (a) a Private Enterprise UE; or (b) an MNO offload to an Enterprise UE that is either Locked or Unlocked; or (2) the case of an Private Enterprise Neutral Host Network in which there is: (a) a private enterprise UE; or (b) an MNO offload to an Enterprise UE that is either Locked or Unlocked.

A locked device is one in which an MNO has subsidized the device and the device is still on a payment plan. In such cases, the MNO typically pushes the enterprise credentials to the UE.

An unlocked device is one in which a customer owns the device (i.e., the device is fully paid off) or the device is an enterprise issued device. In these cases, the enterprise typically pushes the enterprise credentials to the UE.

### Arbitrating Across Multiple CBRS Enterprise Credentials

On the UE side, in some embodiments, it is desirable to be able to distinguish between the different CBRS Enterprise credentials provisioned on the device. Knowing this allows support to be provided for geofencing and to allow UE provisioning to enable traffic steering and mobility transitioning preferences.

The CBRS NID identifies the individual deployments (i.e., allows a distinction to be made between different campuses within the same enterprise network and/or between different enterprise networks. Populating the CBRS NID in the CSG field will imply that the device has been provisioned for CSG whitelist management and UE will perform procedures to support CSG based camping that are standards compliant. The use of this field means that the feature is overloaded. In some embodiments, the ‘Service Provider Name’ field is used to include the CBRS NID, (for example <Enterprise Profile Name>:<CBRS NID>:PESP).

### Supporting HTTP Proxy for CBRS Enterprise LTE Connectivity

The well-known iOS (Apple Operating Systems) supports HTTP proxy settings for Wi-Fi. The UE, when associated with the CBRS LTE network, can support traffic either via: (1) the enterprise core (Private network), assuming the LTE connectivity on the CBRS enterprise network is through the same network as Wi-Fi. It should be noted that HTTP proxy settings may be required for LTE when connected via the enterprise core network. It should be noted that when enabled by an enterprise network, support of HTTP proxy is required; or

(2) the MNO core (Neutral Host). With a neutral host connectivity to an MNO core network, the traffic will be routed to MNO networks and the HTTP proxy deployed on enterprise will not be relevant.

In some embodiments, the UE configuration knows the mode (i.e., whether private/neutral-host) it is operating in before enabling proxy support. The mode is detected in the UE based on the credential used for connectivity. For example, a setting in the SIM profile name may have a specific signature.
In some embodiments, Automatic Proxy Detection may be used, such as WPAD—Web Proxy Auto Discovery.

### Justifications for HTTP Proxy Support

In some embodiments, the IP address assigned to the UE on the enterprise network is a private IP address, similar to what is provided on Wi-Fi. This is different from an MNO network where the UE is provided a public IP address. In some cases, the HTTP proxy support is driven by corporate security policy. The use of the HTTP proxy support primarily, protects the enterprise network. In some embodiments, there may be enterprises that will mandate this. Such use ensures that users and devices can safely connect to the Internet, regardless of where they are connecting from, without the complexity associated with legacy, appliance-based approaches. The use proactively identifies, blocks, and mitigates targeted threats such as, spyware, malware, ransomware, phishing, DNS data exfiltration, and advanced zero-day attacks. In addition, the use provides a central point of forwarding web traffic—a beneficial outcome of exposing a given UE from being tracked for traffic leaving the enterprise campus.

### HTTP Proxy Functions

The HTTP proxy functions in some embodiments have a high performance content filter. The HTTP proxy function Parses every line in the HTTP header for any potentially harmful content before forwarding it. The proxy function only allow content that matches RFC specifications for Web server and clients. It restricts the content allowed into the network, based upon fully a qualified domain name, path name, file name or extension as it appears in the URL. It also restricts the content allowed into the enterprise network based upon MIME type. Furthermore, the proxy function blocks downloads of any unique file type, including client-side executable files like Java and ActiveX, by file header (hexadecimal signature) pattern match. In addition, it examines the HTTP header to make sure it is not from a known source of suspicious content.

A Network-Based Solution for Supporting Routing to HTTP Proxy

Although a UE may not support a user interface for the user to provision the HTTP proxy, this can be done as part of the APN setting provisioned on the device. An HTTP proxy can be accommodated by the network side by performing appropriate routing looking at the packet headers. In some embodiments, this routing function is introduced into the data path when an HTTP proxy is needed on the enterprise campus.

GSMA/SIM

In some embodiments, the following are defined as explicit fields within a given profile. Additional fields to be added to the credential include:

Private network identifier: NID

HTTP proxy

Geofence identifier/server; in which the geofence server and the identifier are used to retrieve the geofence information. In some embodiments, the NID is used for this purpose if there is only one geofence information associated with the NID. In some embodiments, the associated geofence information can support multiple locations separated geographically.

Voice and data offload preferences

Traffic steering across Wi-Fi, LTE, and NR

Charging/Billing rules

SLO/SLA/Grade of service expectations

Although the disclosed method and apparatus is described above in terms of various examples of embodiments and implementations, it should be understood that the particular features, aspects and functionality described in one or more of the individual embodiments are not limited in their applicability to the particular embodiment with which they are described. Thus, the breadth and scope of the claimed invention should not be limited by any of the examples provided in describing the above disclosed embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide examples of instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosed method and apparatus may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described with the aid of block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method for assigning additional identifiers in a communications system, comprising:
a) Identifying a private campus eSIM profile using a Service Provider Name; and
b) Displaying the name on the user interface of the user equipment.
